(19) United States
(12) Patent Application Publication
(10) Pub. No.: US 2026/0328917 A1
(43) Pub. Date: Oct. 22, 2026

(54) OCCLUSION DETECTION METHOD, APPARATUS, TERMINAL DEVICE, AND COMPUTER PROGRAM PRODUCT

(71) Applicant: SUTENG INNOVATION TECHNOLOGY CO., LTD., Shenzhen (CN)

(72) Inventor: Xunjiao CHEN, Shenzhen (CN)

(73) Assignee: SUTENG INNOVATION TECHNOLOGY CO., LTD., Shenzhen (CN)

(21) Appl. No.: 19/651,779

(22) Filed: Apr. 19, 2026

(30) Foreign Application Priority Data
Apr. 21, 2025 (CN) 202510506037.X

(51) Int. Cl. G01S 7/497

(52) U.S. Cl. CPC G01S 7/497; G01S 2007/4975

(57) ABSTRACT

An occlusion detection method is disclosed. The method comprises: performing region-of-interest detection based on point cloud data, and upon determining from the point cloud data that a current-frame point cloud is the first frame having a region of interest, initiating adaptive static frame identification to determine a frame to be matched; performing template matching on the frame to be matched to obtain a template matching result; upon the template matching result indicating successful template matching, recording a target position and recording the frame to be matched as an occluded frame; upon the number of occluded frames being greater than or equal to an occluded-frame threshold, identifying an occlusion-overlap region based on target positions corresponding to a plurality of occluded frames; and if an occlusion-overlap region exists, performing an occlusion warning operation.

### CROSS-REFERENCE TO RELATED APPLICATION

The present application claims the benefit of priority to Chinese Patent Application No. 202510506037.X, filed on Apr. 21, 2025, which is hereby incorporated by reference in its entirety.

### TECHNICAL FIELD

This application belongs to the field of radar technology, and more particularly relates to an occlusion detection method, an apparatus, a terminal device, and a computer program product.

### BACKGROUND

LiDAR (Light Detection and Ranging) is a system that uses laser beams to detect information such as the position and velocity of targets. It offers advantages including high resolution, high sensitivity, strong anti-interference capability, and immunity to dark conditions, and is widely used in autonomous driving, logistics vehicles, robotics, vehicle-road collaboration, and public intelligent transportation systems.

When dirt or foreign objects are present on the window cover of a LiDAR and cause occlusion, the LiDAR's ability to perceive the surrounding environment is impaired. In such cases, the perception algorithm is unable to detect obstacles in the occluded region, creating significant safety hazards.

Therefore, there is an urgent need to accurately identify whether a LiDAR is in an occluded state.

### SUMMARY

Embodiments of the present application provide an occlusion detection method, an apparatus, a terminal device, and a computer program product, which are capable of accurately identifying whether a LiDAR is in an occluded state.

In a first aspect, an embodiment of the present application provides an occlusion detection method comprising: performing region-of-interest detection based on point cloud data, and upon determining from the point cloud data that a current-frame point cloud is the first frame having a region of interest, initiating adaptive static frame identification to determine a frame to be matched; performing template matching on the frame to be matched to obtain a template matching result; upon the template matching result indicating successful template matching, recording a target position and recording the frame to be matched as an occluded frame; upon a number of occluded frames being greater than or equal to an occluded-frame threshold, identifying an occlusion-overlap region based on target positions corresponding to the plurality of occluded frames; and if an occlusion-overlap region exists, performing an occlusion warning operation.

In one implementation of the first aspect, when the LiDAR is an off-axis LiDAR, the region of interest comprises a void region, and the performing region-of-interest detection based on point cloud data comprises: upon the current-frame point cloud comprising positions having a reflectivity of zero, extracting the positions having a reflectivity of zero from the current-frame point cloud to obtain an initial mask region; performing a morphological opening operation on the initial mask region to obtain a post-opening mask region; and if a target void region exists, determining that the current-frame point cloud contains a region of interest, wherein the target void region is the region obtained by removing a theoretical occlusion region and a sky region from the post-opening mask region.

In one implementation of the first aspect, the region of interest comprises a region corresponding to pixels having a detection distance less than a detection-distance threshold, and the performing region-of-interest detection based on point cloud data comprises: determining the detection distance of pixels of the current-frame point cloud based on the current-frame point cloud data; and upon detecting a target pixel having a detection distance less than the detection-distance threshold and a number of target pixels being greater than or equal to a target-pixel threshold, determining that the current-frame point cloud contains a region of interest.

In one implementation of the first aspect, the initiating adaptive static frame identification upon determining from the point cloud data that the current-frame point cloud is the first frame having a region of interest, and determining a frame to be matched, comprises: performing point cloud registration between the current-frame point cloud and an adjacent next-frame point cloud to obtain a first transformation matrix; performing point cloud registration between the current-frame point cloud and a spaced-apart frame to obtain a second transformation matrix; determining the motion state of the LiDAR based on the first transformation matrix and the second transformation matrix; and upon determining that the LiDAR is in a non-motion state, designating the adjacent next-frame point cloud as the frame to be matched, until the LiDAR is detected to be in a motion state or the cumulative frame count exceeds a cumulative-frame-count threshold.

In one implementation of the first aspect, the performing template matching on the frame to be matched to obtain a template matching result comprises: computing, by template matching, a similarity between the region of interest of the frame to be matched and the region of interest of a template image; and determining the template matching result based on the similarity.

In one implementation of the first aspect, the identifying an occlusion-overlap region based on target positions corresponding to the plurality of occluded frames, upon the number of occluded frames being greater than or equal to the occluded-frame threshold, comprises: matching the target-position coordinates of the multiple occluded frames; and if a region having identical position coordinates exists, determining that an occlusion-overlap region exists; otherwise, determining that no occlusion-overlap region exists.

In one implementation of the first aspect, the performing an occlusion warning operation if an occlusion-overlap region exists comprises: determining the number of point cloud frames in which an occlusion-overlap region exists; and if the number of point cloud frames in which an occlusion-overlap region exists is greater than an occlusion-alarm cumulative-frame threshold, performing the occlusion warning operation.

In one implementation of the first aspect, the occlusion detection method further comprises: displaying the occlusion region in the point cloud.

In a second aspect, an embodiment of the present application provides an occlusion detection apparatus comprising: an adaptive module configured to perform region-of-interest detection based on point cloud data, and upon determining from the point cloud data that a current-frame point cloud is the first frame having a region of interest, to initiate adaptive static frame identification to determine a frame to be matched; a matching module configured to perform template matching on the frame to be matched to obtain a template matching result; a recording module configured to, upon the template matching result indicating successful template matching, record a target position and record the frame to be matched as an occluded frame; an overlap identification module configured to, upon a number of occluded frames being greater than or equal to an occluded-frame threshold, identify an occlusion-overlap region based on target positions corresponding to the plurality of occluded frames; and a warning module configured to perform an occlusion warning operation if an occlusion-overlap region exists.

In a third aspect, an embodiment of the present application provides a terminal device comprising a processor, a memory, and a computer program stored in the memory and executable on the processor, wherein when the processor executes the computer program, the method described in the first aspect or any optional implementation of the first aspect is implemented.

In a fourth aspect, an embodiment of the present application provides a computer-readable storage medium storing a computer program, wherein when the computer program is executed by a processor, the method described in the first aspect or any optional implementation of the first aspect is implemented.

In a fifth aspect, an embodiment of the present application provides a computer program product, wherein when the computer program product runs on a terminal device, the terminal device implements the method described in the first aspect or any optional implementation of the first aspect.

Compared with the prior art, the advantageous effects of the embodiments of the present application are as follows.

The occlusion detection method, apparatus, terminal device, and computer program product provided by the embodiments of the present application, through adaptive static frame identification, are capable of accurately identifying the frame to be matched for detecting whether occlusion is present, thereby effectively reducing the impact of erroneous motion-state identification on occlusion detection, accurately identifying occlusion conditions such as window cover contamination of a LiDAR, and providing early warnings, thus enhancing the safety performance of the LiDAR.

### BRIEF DESCRIPTION OF DRAWINGS

To more clearly illustrate the technical solutions in the embodiments of the present application, the following briefly introduces the drawings used for describing the embodiments or the prior art. Obviously, the drawings described below are only some embodiments of the present application. For those of ordinary skill in the art, other drawings can be obtained based on these drawings without creative effort.

FIG. 1 is a schematic diagram of an application scenario of a LiDAR according to an embodiment of the present application;

FIG. 2 is a structural schematic diagram of a LiDAR according to an embodiment of the present application;

FIG. 3 is a schematic flowchart illustrating an implementation of an occlusion detection method according to an embodiment of the present application;

FIG. 4 is a schematic diagram of a process for detecting void regions according to an embodiment of the present application;

FIG. 5 is a schematic diagram of a theoretical occlusion region of a LiDAR according to an embodiment of the present application;

FIG. 6 is a schematic diagram of another process for detecting void regions according to an embodiment of the present application;

FIG. 7 is a schematic diagram of an adaptive static frame identification process according to an embodiment of the present application;

FIG. 8a-FIG. 8d are schematic flowcharts illustrating an implementation of another occlusion detection method according to an embodiment of the present application;

FIG. 9 is a structural schematic diagram of an occlusion detection apparatus according to an embodiment of the present application; and

FIG. 10 is a structural schematic diagram of a terminal device according to an embodiment of the present application.

### DETAILED DESCRIPTION

In the following description, for purposes of explanation rather than limitation, details such as system structures and techniques are set forth in order to provide a thorough understanding of the embodiments of the present application. However, it will be apparent to those skilled in the art that the present application may be practiced in other embodiments that depart from these specific details. In other instances, detailed descriptions of well-known systems, devices, circuits, and methods are omitted so as not to obscure the description of the present application.

It should be understood that the term “and/or” used in the description and the appended claims of the present application refers to any and all possible combinations of one or more of the associated listed items, and encompasses such combinations. In addition, in the description and claims of the present application, the terms “first,” “second,” “third,” and the like are used only to distinguish descriptions and are not to be construed as indicating or implying relative importance.

It should also be understood that references in the description of the present application to “one embodiment” or “some embodiments” and the like mean that a particular feature, structure, or characteristic described in connection with the embodiment is included in one or more embodiments of the present application. Therefore, the phrases “in one embodiment,” “in some embodiments,” “in other embodiments,” and “in still other embodiments” appearing at different places throughout this specification do not necessarily all refer to the same embodiment, but rather mean “one or more but not all embodiments,” unless the context specifically indicates otherwise. The terms “comprise,” “include,” “have,” and variations thereof all mean “including but not limited to,” unless specifically indicated otherwise.

LiDAR (Light Detection and Ranging) is a radar system that uses laser beams to detect information such as the position and velocity of targets. In addition to detecting the distance of objects, it can also detect the reflectivity of objects for target identification. The working principle of LiDAR involves transmitting a detection signal toward a target; upon reaching the target, the detection signal is reflected by the target object to form echo data. The LiDAR receives the signal (echo data) reflected from the target and determines information about the target based on the echo data, such as target distance, position, height, velocity, attitude, shape, and reflectivity, thereby achieving target detection, target tracking, and target identification. Among these, the reflectivity of an object refers to the ratio of the radiant energy reflected by the object to the total radiant energy of the incident signal. Different objects have different reflectivities; the reflectivity of an object is primarily determined by factors such as the surface characteristics of the object, the wavelength of the incident signal, and the angle of incidence.

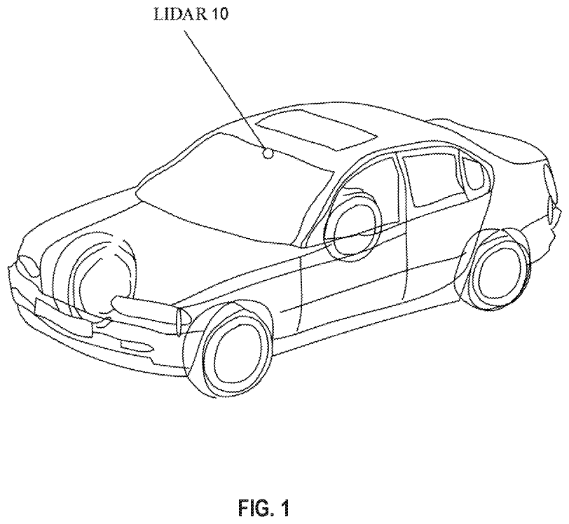

FIG. 1 exemplarily illustrates a schematic diagram of an application scenario of a LiDAR according to an embodiment of the present application. As shown in FIG. 1, in this example, the LiDAR 10 may be mounted on a vehicle, and is therefore referred to as a vehicular LiDAR system. The LiDAR may also be installed on other mobile devices, such as a mobile robot or a ship. The present application imposes no limitation on the type of mobile device.

The LiDAR may be a mechanical LiDAR, a solid-state LiDAR, or a semi-solid-state LiDAR. The present application imposes no limitation in this regard.

In the present application, the LiDAR may comprise a control module and a data processing module. The control module is configured to control the LiDAR to emit detection laser pulses and to control the LiDAR to receive echo laser pulses. The data processing module is configured to process the echo data received by the radar and to output corresponding detection data.

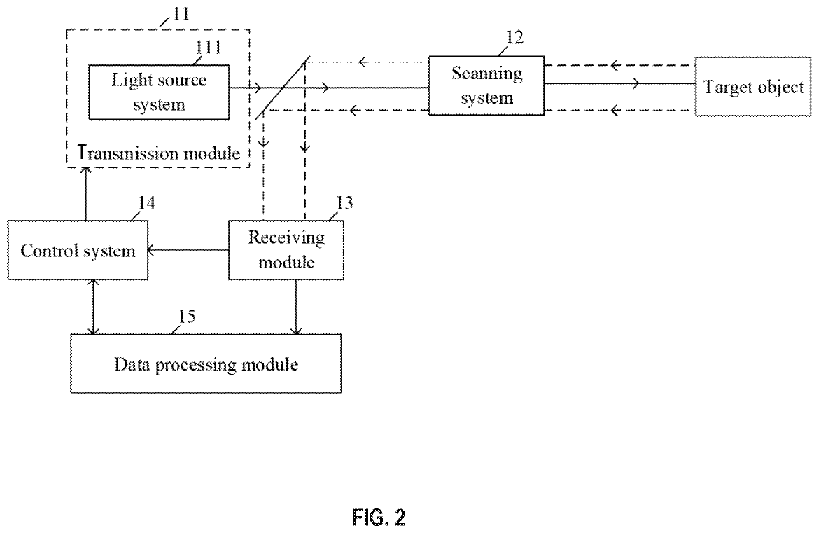

For example, referring to FIG. 2, which illustrates a structural schematic diagram of a LiDAR. As shown in FIG. 2, the LiDAR 10 typically comprises a transmitting module 11, a scanning system 12, a receiving module 13, a control module 14, and a data processing module 15. The transmitting module 11 may comprise a light source system 111.

The light source system 111 is configured to generate laser beams needed for detection by the LiDAR 10; specifically, the light source system 111 may comprise optical components such as a laser and a transmitting lens assembly. The scanning system 12 is configured to deflect the angle of the laser beams generated by the light source system 111, so that the laser beams can irradiate different positions at different times. The scanning system 12 may be a mechanical scanning system (i.e., a rotary drive platform) or a semi-solid-state scanning system (i.e., a rotating mirror, a galvanometer mirror, or a combination of both). The present application imposes no limitation on the form of the scanning system.

It should be understood that the LiDAR in the present application may also be a solid-state LiDAR that achieves scanning by controlling light sources at different angles to emit light in sequence. After the laser beams emitted by the light source system reach the target object and are reflected thereby, the reflected light pulses are received by a receiving sensor 131 in the receiving module 13, and then processed by an echo signal processing circuit to generate corresponding detection information.

The control module 14 is configured to control the LiDAR to emit detection laser pulses and to control the LiDAR to receive echo laser pulses. The data processing module 15 is configured to process the echo data received by the radar and to output corresponding detection data.

When dirt or an obstruction is present on the window cover of the LiDAR, fixed point cloud voids or energy-attenuation features appear on consecutively moving point cloud frames. This characteristic is exploited for real-time detection and reporting of LiDAR occlusion.

It should be understood that the occurrence of voids caused by ineffective detection due to occlusion is applicable to an off-axis LiDAR. The off-axis LiDAR specifically refers to a LiDAR in which the optical axis of the transmitting optical system and the optical axis of the receiving optical system are designed to be on different optical axes. Because the transmitting optical system and the receiving optical system are designed on different optical axes, when dirt or an obstruction is present on the window cover, the LiDAR cannot receive the echo from the occluded region, thereby resulting in voids in the point cloud.

It should be understood that, due to occlusion, a co-axial LiDAR can receive an echo; the occlusion may manifest as a detection distance smaller than the distance between the window cover and the transmitting optical component. Therefore, the presence of a region of interest can be determined based on the detection distance. The co-axial LiDAR specifically refers to a LiDAR in which the optical axis of the transmitting optical system and the optical axis of the receiving optical system are designed to be on the same optical axis. Since the transmitting and receiving optical systems are on the same optical axis, the laser emitted and reflected by the occluding object can be received by the receiving system.

For mobile devices equipped with LiDAR, if the mobile device is in a stationary state, Iterative Closest Point (ICP) point cloud registration between frames can be used to detect occluding objects; if the mobile device is in motion, inter-frame point cloud registration cannot be used for this purpose. Currently, inertial measurement units (IMUs) on mobile devices or LiDARs can output, in real time, three-axis linear acceleration and angular velocity of the mobile device, thereby theoretically enabling the position and current motion state of the mobile device in space to be obtained through integration. However, due to the limitations of IMU devices, when a mobile device is in approximately uniform linear motion, the three-axis linear acceleration output by the IMU approaches zero, thereby causing the motion state to be indistinguishable from a stationary state. In such cases, occlusion detection via ICP may produce false positives. Therefore, there is an urgent need for an occlusion detection method for determining whether a LiDAR is being occluded by dirt or foreign objects.

Based on this, the embodiments of the present application provide an occlusion detection method. Through adaptive identification of static frames, the method can accurately identify frames to be matched for determining whether occlusion exists, thereby effectively reducing the impact of erroneous motion-state recognition on occlusion detection. As a result, occlusion conditions such as contamination of the LiDAR window can be accurately identified and early warnings can be issued, thereby improving the safety performance of the LiDAR.

The occlusion detection method provided by the embodiments of the present application is described in detail below with reference to the accompanying drawings.

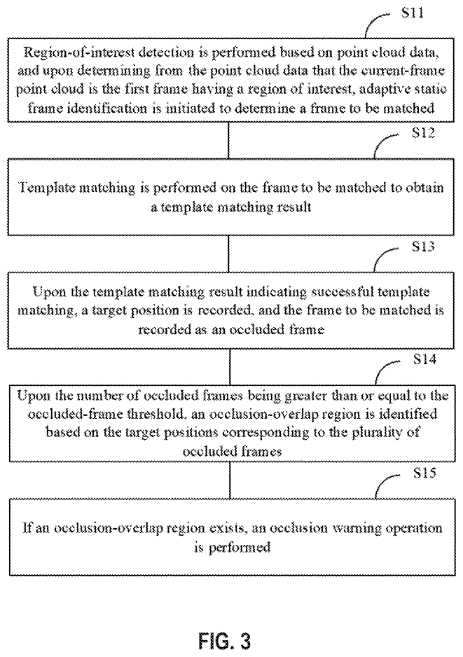

Referring to FIG. 3, which illustrates a schematic flowchart of an implementation of the occlusion detection method provided by an embodiment of the present application. It should be noted that the executing entity of the occlusion detection method may be the LiDAR 10 described above, specifically the data processing module within the LiDAR 10.

In other embodiments, the executing entity of the occlusion detection method may also be a terminal device communicatively connected to the LiDAR 10. The terminal device may be a mobile phone, a desktop computer, a laptop computer, a tablet computer, or a wearable device, or may be a cloud server, a radar-assisted computer, or other devices used in various application scenarios. The present application imposes no specific limitation in this regard. The following description uses the LiDAR 10 as the executing entity.

As shown in FIG. 3, the occlusion detection method may comprise steps S11 through S15.

In S11, region-of-interest detection is performed based on point cloud data, and upon determining from the point cloud data that the current-frame point cloud is the first frame having a region of interest, adaptive static frame identification is initiated to determine a frame to be matched.

As an example, the point cloud data may be point cloud data formed by echo data received by the LiDAR after transmitting detection signals, or it may be point cloud data that has undergone denoising filtering.

As an example, when the LiDAR performs detection scanning, it rotates through a preset rotation angle within the horizontal resolution angle range. At each horizontal resolution angle, the LiDAR is controlled to transmit detection signals channel by channel within the vertical angle range and to receive corresponding echo signals, thereby obtaining the column or row of point cloud data corresponding to that horizontal resolution angle. The collection of all columns or all rows of point cloud data constitutes one frame of point cloud data (called a point cloud frame) obtained by the LiDAR.

As an example, the point cloud data may be real-time point cloud data generated by the LiDAR. Performing occlusion detection using real-time point cloud data can improve the real-time performance of occlusion detection.

In the embodiments of the present application, the region of interest may refer to a region where occlusion may exist, such as a region where point cloud voids exist, or a region where the detection distance is less than a detection-distance threshold.

In one embodiment of the present application, for an off-axis LiDAR, the region of interest may be a void region, meaning that performing region-of-interest detection based on point cloud data specifically means performing void region detection based on point cloud data. For a co-axial LiDAR, occlusion may manifest as a detection distance smaller than the distance between the window cover and the transmitting optical component; therefore, the presence of a region of interest can be determined based on the detection distance.

It should be noted that the detection-distance threshold may be determined based on the distance between the window cover and the transmitting optical component. The present embodiment imposes no specific limitation in this regard.

In specific applications, the intuitive manifestation of a point cloud void is a reflection intensity equal to zero. Therefore, the position of voids can be identified based on the reflection intensity of the point cloud data. Performing void detection based on point cloud data may comprise: for each frame of point cloud data, extracting the positions in the current-frame point cloud data having a reflectivity of zero to obtain an initial mask region, and removing invalid point clouds from the initial mask region to obtain a target void region.

As an example, the performing region-of-interest detection based on point cloud data may comprise the following steps.
upon the current-frame point cloud comprising positions having a reflectivity of zero, extracting the positions having a reflectivity of zero from the current-frame point cloud to obtain an initial mask region;
performing a morphological opening operation on the initial mask region to obtain a post-opening mask region; and
if a target void region exists, determining that the current-frame point cloud contains a region of interest, wherein the target void region is the region obtained by removing a theoretical occlusion region and a sky region from the post-opening mask region.

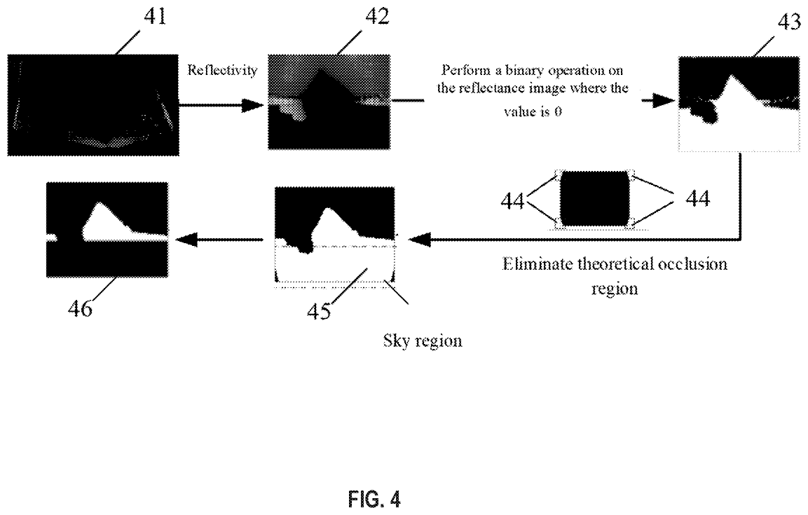

For example, referring to FIG. 4, which illustrates a schematic diagram of a process for detecting void regions provided by an embodiment of the present application. As shown in FIG. 4, reference numeral 41 denotes the current-frame point cloud, 42 denotes the reflectivity image of the current-frame point cloud, 43 denotes the image binarized based on zero reflectivity (white regions correspond to areas of zero reflectivity), 44 denotes a schematic of the theoretical occlusion region, 45 denotes the binarized image with the sky occlusion region, and 46 denotes the schematic of the target void region.

It should be noted that the morphological opening operation may refer to first performing an erosion operation on the image and then performing a dilation operation, which effectively removes noise and smooths boundaries.

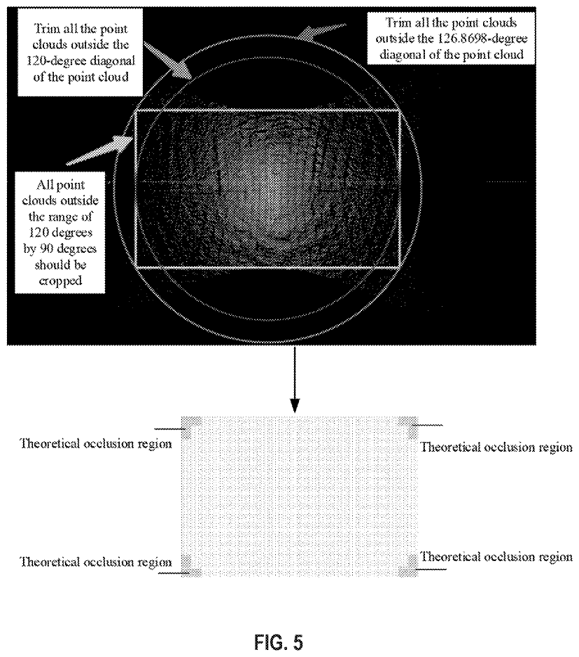

The theoretical occlusion region refers to the theoretical occlusion region of the LiDAR, i.e., some boundaries of the point cloud obtained by scanning with the LiDAR will theoretically exhibit occlusion. For example, as shown in FIG. 5, occlusion exists at the four corner positions. The theoretical occlusion region may differ for different LiDAR models. Some LiDARs have theoretical occlusion regions at all four corner positions as shown in FIG. 5, while others have theoretical occlusion regions at only some corner positions. Therefore, the theoretical occlusion region can be determined based on the LiDAR model. The present application imposes no specific limitation in this regard.

It should also be noted that in outdoor or open scenes, most of the sky region includes invalid points with zero reflectivity. Accordingly, void regions in the sky portion may be excluded from consideration.

It is understood that, in addition to filtering point cloud data based on reflectivity, invalid point clouds can also be filtered based on the theoretical detection range of the LiDAR, i.e., point clouds exceeding the theoretical detection range can be removed.

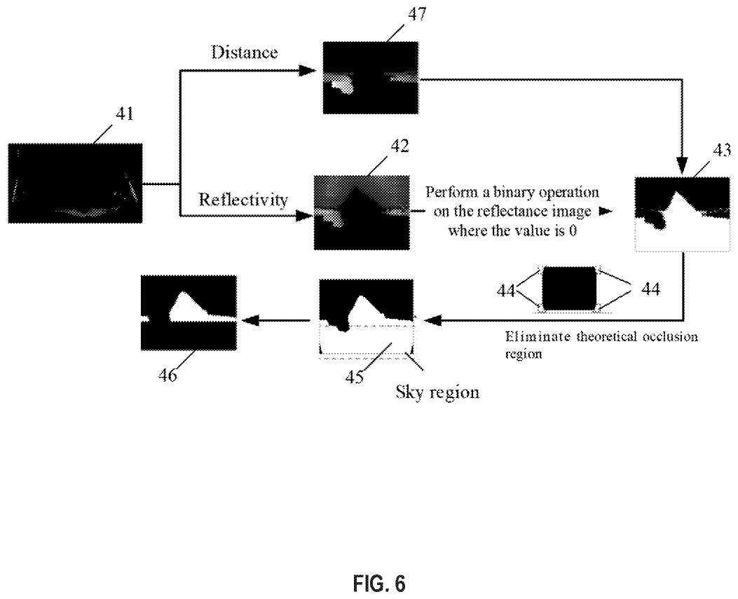

For example, referring to FIG. 6, which illustrates a schematic diagram of another process for detecting void regions provided by an embodiment of the present application. As shown in FIG. 6, reference numeral 47 denotes the point cloud image after removing point clouds that exceed the theoretical detection range.

It is understood that if void detection yields a target void region, the current-frame point cloud contains a void; otherwise, the current-frame point cloud contains no void.

In specific applications, the term “first frame with a region of interest” (also referred to herein as “first-frame void” in the context of off-axis systems) refers to the first point cloud frame in which a region of interest is detected. It is understood that the LiDAR can perform region-of-interest detection on each frame to identify whether a region of interest exists in that point cloud frame. If a region of interest exists, it can be further determined whether that point cloud frame is the first frame in which a region of interest is detected. If it is the first such frame, adaptive static frame identification can be initiated; the purpose of adaptive static frame identification is to determine the frame to be matched for template matching.

In some embodiments of the present application, if the LiDAR is a co-axial LiDAR, the performing region-of-interest detection based on point cloud data may comprise: determining the detection distance of pixels in the current-frame point cloud based on the current-frame point cloud data; and upon detecting a target pixel having a detection distance less than the detection-distance threshold and the number of target pixels being greater than or equal to a target-pixel threshold, determining that the current-frame point cloud contains a region of interest.

In the embodiments of the present application, the detection-distance threshold may be determined based on the distance between the window cover and the transmitting optical component; and the number of target pixels may be set based on actual application needs. The present application imposes no specific limitation in this regard.

In specific applications, determining whether a LiDAR is in a stationary state may be performed in various ways. For devices equipped with an IMU, the IMU may be used for such determination. However, as previously mentioned, the IMU has certain limitations, including the possibility of misidentifying near-uniform-linear-motion conditions as a stationary state. Additionally, the motion information of the mobile device on which the LiDAR is mounted may be used to assist in determining whether the LiDAR is stationary. The embodiments of the present application determine whether the LiDAR is in a stationary or moving state by way of adaptive static frame identification, which involves setting a dynamic/static threshold and then adjusting the interval between point cloud frames for point cloud registration based on this threshold, thereby confirming the motion state of the LiDAR.

It should be noted that the dynamic/static threshold can be set based on actual conditions, for example it may be set to 1 m. The present embodiment imposes no specific limitation in this regard.

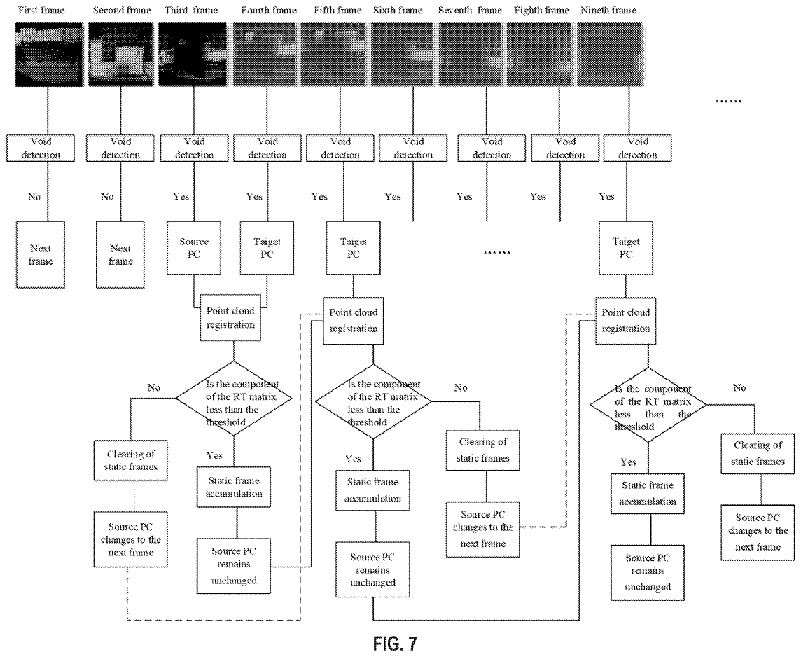

For example, referring to FIG. 7, which illustrates a schematic diagram of the adaptive static frame identification process provided by an embodiment of the present application. As shown in FIG. 7, the void detection result for the first frame is no void; the void detection result for the second frame is also no void; the void detection result for the third frame is void present—the third frame can therefore be considered the first frame with a void. At this point, adaptive static frame identification is initiated: the third frame and the fourth frame undergo point cloud registration, yielding the transformation matrix between the third and fourth frames, which is then used to determine whether the LiDAR is in a motion state.

Because the LiDAR may move slowly, if ICP calculation is performed only on adjacent frames, the small changes in the RT matrix may consistently indicate a stationary state, leading to missed detections. Therefore, ICP calculation should also be performed on frames spaced several frames apart, for example performing ICP between the third and fifth frames. Sometimes the LiDAR may accelerate or make large turns. If ICP calculation is performed only on frames spaced several frames apart, the large scene difference may prevent convergence. Therefore, ICP calculation should also be performed on adjacent frames. The number of frames apart can be dynamic: if ICP between the third and fifth frames can confirm that the LiDAR is in motion, the spacing is 1 frame; if ICP between the third and seventh frames is needed, the spacing is 3 frames (i.e., the fourth, fifth, and sixth frames are skipped).

In one embodiment of the present application, the initiating adaptive static frame identification upon determining from the point cloud data that the current-frame point cloud is the first frame having a region of interest, and determining a frame to be matched, may comprise the following steps:
performing point cloud registration between the current-frame point cloud and an adjacent next-frame point cloud to obtain a first transformation matrix;
performing point cloud registration between the current-frame point cloud and a spaced-apart frame to obtain a second transformation matrix;
determining the motion state of the LiDAR based on the first transformation matrix and the second transformation matrix; and
upon determining that the LiDAR is in a non-motion state, designating the adjacent next-frame point cloud as the frame to be matched, until the LiDAR is detected to be in a motion state or the cumulative frame count exceeds a cumulative-frame-count threshold.

It should be noted that the spaced-apart frame may be a frame spaced one, two, three, or more frames apart. A static-frame cumulative threshold may be set. When the count is determined to be greater than or equal to the static-frame cumulative threshold, the LiDAR is determined to be in a stationary state.

It should be noted that the static-frame cumulative threshold may be set based on actual application needs; the present embodiment imposes no specific limitation in this regard.

In specific applications, the process of point cloud registration may refer to existing point cloud registration methods. The present embodiment will not describe them in further detail.

In specific applications, if the rotation component AR of the motion state of the first transformation matrix is greater than a rotation-component threshold, or the translation component AT of the motion state is greater than a translation-component threshold, or the rotation component AR of the motion state of the second transformation matrix is greater than the rotation-component threshold, or the translation component AT of the motion state is greater than the translation-component threshold, then the LiDAR may be considered to be in a motion state.

It should be noted that the translation-component threshold and rotation-component threshold may be set according to actual application requirements. The present application imposes no specific limitation in this regard.

In S12, template matching is performed on the frame to be matched to obtain a template matching result.

As an example, template matching can be used to determine the similarity of the region of interest between point cloud frames, and based on the similarity of the region of interest, to determine whether the regions of interest between point cloud frames match.

In specific applications, the Normalized Cross-Correlation (NCC) algorithm is a template matching algorithm commonly used in image processing. Its mathematical principle is to compute the similarity between the template image and a local region of the frame to be matched, and to find the best matching position by maximizing the NCC value. The specific calculation formula is as follows:

$$N C C ( u , v ) = \frac{{\sum }_{x , y} ( T ( x , y ) - \overline{T} ) ( I ( x + u , y + v ) - {\overline{I}}_{u , v} )}{\sqrt{{\sum }_{x , y} {( T ( x , y ) - \overline{T} )}^{2} {\sum }_{x , y} {( I ( x + u , y + v ) - {\overline{I}}_{u , v} )}^{2}}} ;$$

where T(x,y) is the pixel value of the template image, I(x+u,y+v) is the pixel value of the frame to be matched at position (u,v), T̅ is the mean value of the template image, and Ǐu,v is the mean value of the corresponding window of the target image at position (u,v).

It should be noted that, in the occlusion detection scheme of the present application, the template matching scheme for regions of interest converts both the template image and the frame to be matched into binary images. Therefore, to simplify computation, a sliding-window XOR operation between the template image and the frame to be matched may also be used directly to compute similarity.

In other implementations of the present application, in addition to using NCC for template matching, other algorithms such as Mean Squared Error (MSE) and Structural Similarity (SSIM) may also be used. The present application imposes no specific limitation in this regard.

It should be noted that the template image in the embodiments of the present application is the template image marked during the adaptive static frame identification process. Specifically, it may be the template image corresponding to the first frame having a region of interest, or it may be the updated template image during the static-frame matching process.

In S13, upon the template matching result indicating successful template matching, a target position is recorded, and the frame to be matched is recorded as an occluded frame.

When template matching between two frames is successful, the position of the successful match, i.e., the target position, is recorded, and the count of occluded frames is accumulated.

When template matching between two frames fails, the situation is deemed not to be a dirt-occlusion condition, and the next round of detection restarts.

In S14, upon the number of occluded frames being greater than or equal to the occluded-frame threshold, an occlusion-overlap region is identified based on the target positions corresponding to the plurality of occluded frames.

In S15, if an occlusion-overlap region exists, an occlusion warning operation is performed.

When the accumulated count of occluded frames reaches a value greater than or equal to the occluded-frame threshold, it is possible to detect whether there are overlapping position regions among the matching-successful positions of multiple adjacent frames, i.e., the target positions. Specifically, the void positions of the occluded frames undergo occlusion-overlap position detection. If overlapping positions exist, the occlusion-overlap region is considered to be a dirt-occlusion region, and a dirt-occlusion warning can then be issued.

In specific applications, the number of point cloud frames in which an occlusion-overlap region exists among all occluded frames' target positions can be computed, and it is determined whether this number exceeds the occlusion-alarm cumulative-frame threshold. If the number of point cloud frames in which an occlusion-overlap region exists is greater than the occlusion-alarm cumulative-frame threshold, the occlusion warning operation is performed.

It should be noted that the occluded-frame threshold and the occlusion-alarm cumulative-frame threshold may be set based on actual application requirements. The present application imposes no limitation in this regard.

The occlusion warning operation may be performed by the LiDAR; specifically, it may involve transmitting an occlusion alarm message to the application system on which the LiDAR is mounted. For example, if the LiDAR is a vehicular radar, the occlusion alarm message may be sent to the vehicle human-machine interaction system so that an alarm is issued through the vehicle human-machine interaction system. As another example, if the LiDAR is mounted in a robot, the occlusion alarm message may be sent to the robot's central control system, and the robot's central control system identifies the content of the alarm message and issues an alarm accordingly.

In some embodiments, the occlusion warning operation may also be performed by a cloud processor, electronic device, or other entity performing the occlusion detection operation. The present application imposes no specific limitation in this regard.

It is understood that the examples above are merely partial implementation examples of occlusion alarm and not limitations thereof; other methods capable of issuing an occlusion alarm may be used to implement the occlusion warning, and the present application imposes no specific limitation in this regard.

In one embodiment of the present application, the occlusion region in the point cloud may also be displayed. This makes the occlusion region visible, facilitating cleaning of window cover contamination or removal of foreign objects.

It should be noted that the occlusion-overlap position detection mentioned above specifically involves matching the target-position coordinates of multiple occluded frames to determine whether a region with identical position coordinates exists. If such a region exists, an occlusion-overlap region is determined to exist; otherwise, no occlusion-overlap region is determined to exist.

From the foregoing, it can be seen that the occlusion detection method provided by the embodiments of the present application, through adaptive static frame identification, can accurately identify the frame to be matched for occlusion detection, thereby effectively reducing the impact of erroneous motion-state identification on occlusion detection, accurately identifying occlusion conditions such as window cover contamination of a LiDAR, and providing early warnings, thus enhancing the safety performance of the LiDAR.

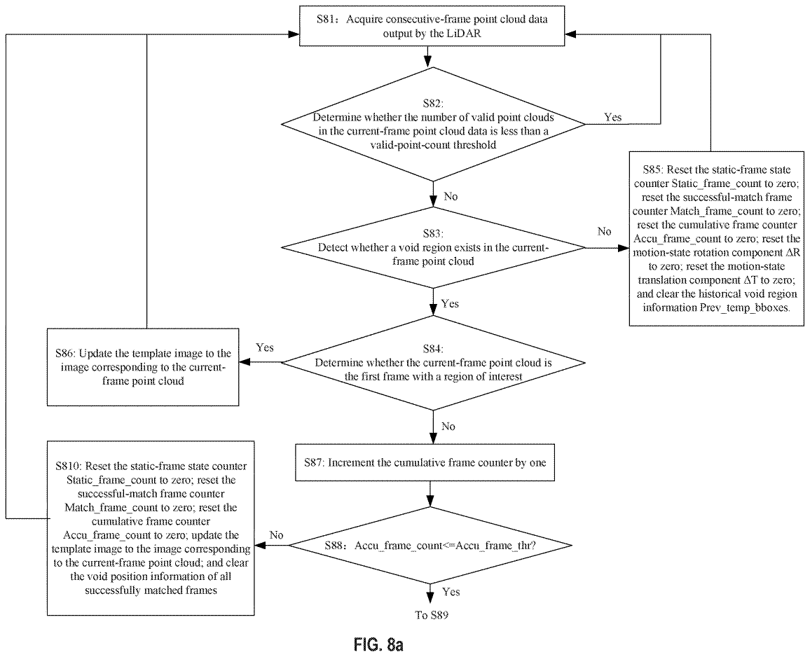

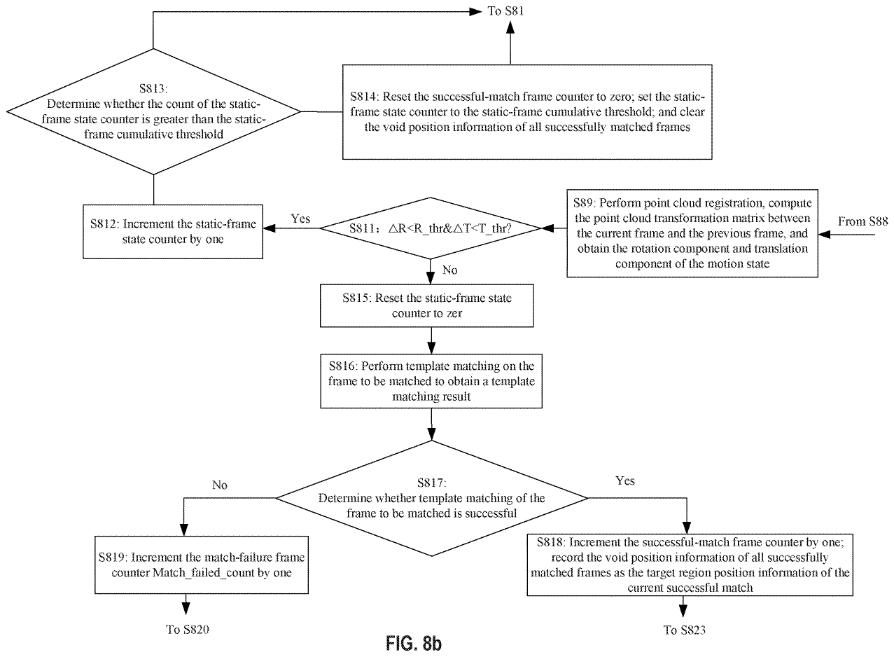

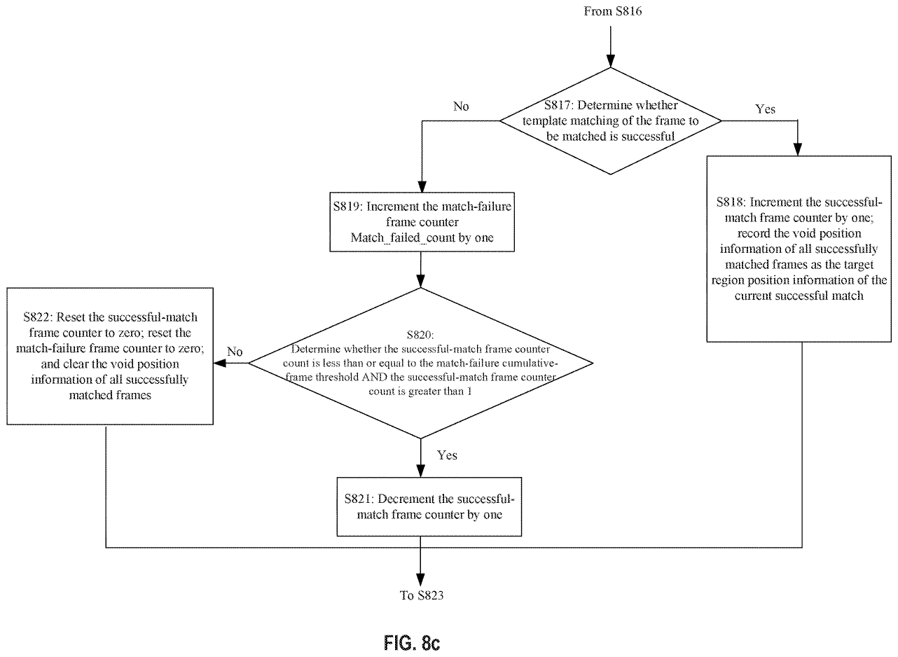

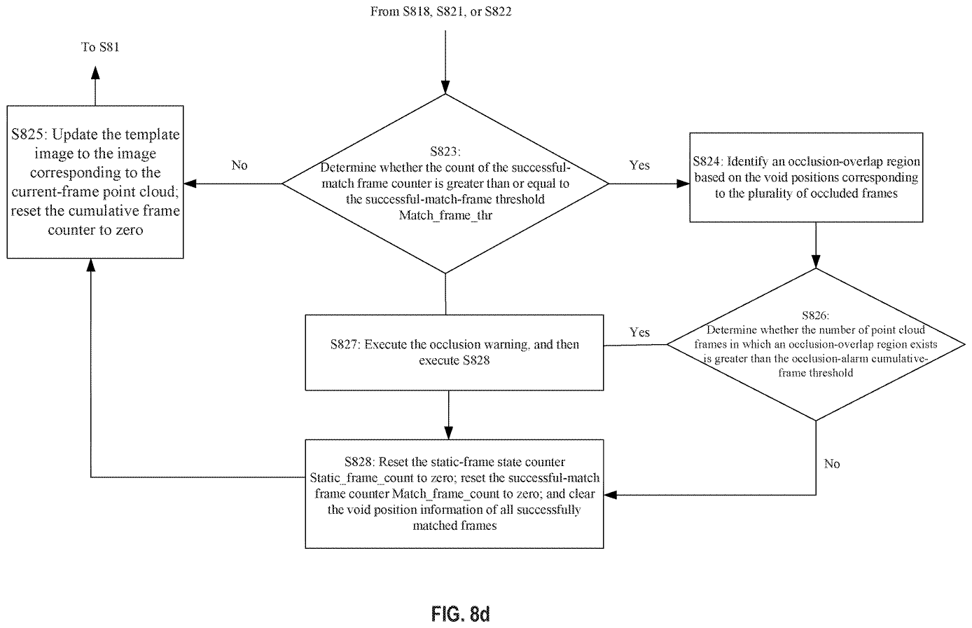

In some embodiments of the present application, referring to FIG. 8a-FIG. 8d, which illustrate schematic flowcharts of another implementation of the occlusion detection method provided by another embodiment of the present application. Distinguishing from the previous embodiment, as shown in FIGS. 8a-8d, the occlusion detection method may comprise the following steps.
S81: Acquire consecutive-frame point cloud data output by the LiDAR.
S82: Determine whether the number of valid point clouds in the current-frame point cloud data is less than a valid-point-count threshold. If yes, return to execute S81; otherwise execute S83.

The valid-point-count threshold may be set based on actual application requirements. The present application imposes no specific limitation in this regard.

In specific applications, the valid point clouds in the current-frame point cloud data can be determined using existing point cloud detection methods. The present embodiment will not repeat the description.
S83: Detect whether a void region exists in the current-frame point cloud. If yes, execute S84; otherwise execute S85.

For the content relating to detecting whether a void region exists in the current-frame point cloud, reference may be made to the relevant description in S11; no further elaboration is provided here.
S84: Determine whether the current-frame point cloud is the first frame with a region of interest. If yes, execute S86; otherwise execute S87.

For the content relating to determining whether the current-frame point cloud is the first frame with a region of interest, reference may be made to the relevant description in S11; no further elaboration is provided here.
S85: Reset the static-frame state counter Static_frame_count to zero; reset the successful-match frame counter Match_frame_count to zero; reset the cumulative frame counter Accu_frame_count to zero; reset the motion-state rotation component AR to zero; reset the motion-state translation component ΔT to zero; and clear the historical void region information Prev_temp_bboxes.
S86: Update the template image to the image corresponding to the current-frame point cloud and return to execute S81.

Specifically, this comprises updating the point cloud of the template image to the current-frame point cloud, updating the template reflectivity image to the current reflectivity image, updating the template distance map to the current distance map, updating the template non-zero reflectivity region to the non-zero reflectivity region of the current-frame point cloud, and updating the template zero-reflectivity region to the zero-reflectivity region of the current-frame point cloud.
S87: Increment the cumulative frame counter by one.
S88: Determine whether the cumulative frame counter Accu_frame_count is less than or equal to the cumulative-frame threshold Accu_frame_thr. If yes, execute S89; otherwise execute S810.

The cumulative-frame threshold may be set based on actual application requirements. The present application imposes no specific limitation in this regard.
S89: Perform point cloud registration, compute the point cloud transformation matrix between the current frame and the previous frame, and obtain the rotation component and translation component of the motion state.
S810: Reset the static-frame state counter Static_frame_count to zero; reset the successful-match frame counter Match_frame_count to zero; reset the cumulative frame counter Accu_frame_count to zero; update the template image to the image corresponding to the current-frame point cloud; and clear the void position information of all successfully matched frames.
S811: Determine whether the rotation component AR of the motion state is less than the rotation-component threshold R_thr AND the translation component ΔT of the motion state is less than the translation-component threshold T_thr. If yes, execute S812; otherwise execute S815.
S812: Increment the static-frame state counter by one.
S813: Determine whether the count of the static-frame state counter is greater than the static-frame cumulative threshold. If yes, execute S814; otherwise return to execute S81.
S814: Reset the successful-match frame counter to zero; set the static-frame state counter to the static-frame cumulative threshold; and clear the void position information of all successfully matched frames.
S815: Reset the static-frame state counter to zero.
S816: Perform template matching on the frame to be matched to obtain a template matching result.

For S816, reference may be made to the relevant description in S12; no further elaboration is provided here.
S817: Determine whether template matching of the frame to be matched is successful. If yes, execute S818; otherwise execute S819.
S818: Increment the successful-match frame counter by one; record the void position information of all successfully matched frames as the target region position information of the current successful match.
S819: Increment the match-failure frame counter Match_failed_count by one.
S820: Determine whether the successful-match frame counter count is less than or equal to the match-failure cumulative-frame threshold AND the successful-match frame counter count is greater than 1. If yes, execute S821; otherwise execute S822.

The match-failure cumulative-frame threshold may be set based on actual application requirements; the present embodiment imposes no specific limitation in this regard.
S821: Decrement the successful-match frame counter by one.
S822: Reset the successful-match frame counter to zero; reset the match-failure frame counter to zero; and clear the void position information of all successfully matched frames.
S823: Determine whether the count of the successful-match frame counter is greater than or equal to the successful-match-frame threshold Match_frame_thr. If yes, execute S824; otherwise execute S825.

The successful-match-frame threshold may be set based on actual application requirements; the present embodiment imposes no specific limitation in this regard.
S824: Identify an occlusion-overlap region based on the void positions corresponding to the plurality of occluded frames.

For the content of S824, reference may be made to the description of S14; no further elaboration is provided here.
S825: Update the template image to the image corresponding to the current-frame point cloud; reset the cumulative frame counter to zero; and return to execute S81.
S826: Determine whether the number of point cloud frames in which an occlusion-overlap region exists is greater than the occlusion-alarm cumulative-frame threshold. If yes, execute S827; otherwise execute S828.

The occlusion-alarm cumulative-frame threshold may be set based on actual application requirements; the present embodiment imposes no specific limitation in this regard.
S827: Execute the occlusion warning, and then execute S828.
S828: Reset the static-frame state counter Static_frame_count to zero; reset the successful-match frame counter Match_frame_count to zero; and clear the void position information of all successfully matched frames.

From the foregoing, it can be seen that the occlusion detection method provided by the embodiments of the present application is capable of accurately identifying whether the LiDAR has window cover contamination or foreign object occlusion, by combining static-frame counting, cumulative frame counting, occluded-frame counting, and matched-frame counting with void detection, template matching, and occlusion-overlap region detection.

It should be understood that the sequence numbers of the steps in the foregoing embodiments do not imply the order of execution; the execution order of each process should be determined by its function and inherent logic, and shall not constitute any limitation on the implementation process of the embodiments of the present application.

Based on the occlusion detection method provided by the foregoing embodiments, embodiments of the present application further provide an occlusion detection apparatus that implements the foregoing method.

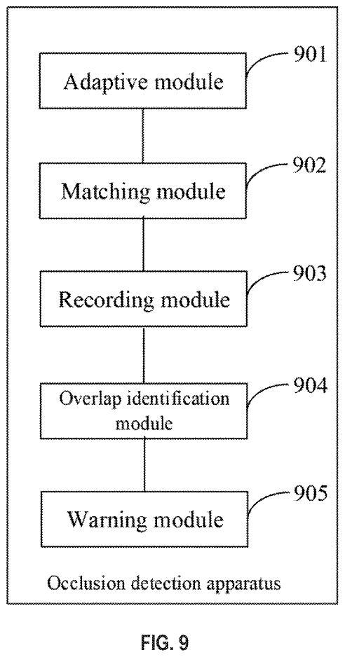

Referring to FIG. 9, which is a structural schematic diagram of an occlusion detection apparatus provided by an embodiment of the present application. In the embodiments of the present application, the occlusion detection apparatus is applied to a radar system; the units comprised in the occlusion detection apparatus are configured to perform the steps in the embodiment corresponding to FIG. 9. For details, please refer to FIG. 9 and the relevant description in the embodiments corresponding to FIG. 9. For ease of explanation, only the parts relevant to this embodiment are shown. As shown in FIG. 9, the occlusion detection apparatus may comprise an adaptive module 901, a matching module 902, a recording module 903, an overlap identification module 904, and a warning module 905.

The adaptive module 901 is configured to perform region-of-interest detection based on point cloud data, and upon determining from the point cloud data that the current-frame point cloud is the first frame having a region of interest, to initiate adaptive static frame identification to determine a frame to be matched.

The matching module 902 is configured to perform template matching on the frame to be matched to obtain a template matching result.

The recording module 903 is configured to, upon the template matching result indicating successful template matching, record a target position and record the frame to be matched as an occluded frame.

The overlap identification module 904 is configured to, upon the number of occluded frames being greater than or equal to an occluded-frame threshold, identify an occlusion-overlap region based on target positions corresponding to the plurality of occluded frames.

The warning module 905 is configured to perform an occlusion warning operation if an occlusion-overlap region exists.

In one implementation, when the LiDAR is an off-axis LiDAR, the region of interest comprises a void region, and the adaptive module 901 may comprise a reflectivity identification unit, an opening-operation unit, and a first determination unit.

The reflectivity identification unit is configured to, upon the current-frame point cloud comprising positions having a reflectivity of zero, extract the positions having a reflectivity of zero from the current-frame point cloud to obtain an initial mask region.

The opening-operation unit is configured to perform a morphological opening operation on the initial mask region to obtain a post-opening mask region.

The first determination unit is configured to, if a target void region exists, determine that the current-frame point cloud contains a region of interest, wherein the target void region is the region obtained by removing a theoretical occlusion region and a sky region from the post-opening mask region.

In one implementation, when the LiDAR is a co-axial LiDAR, the adaptive module 901 may comprise a distance detection unit and a second determination unit.

The distance detection unit is configured to determine the detection distance of pixels of the current-frame point cloud based on the current-frame point cloud data.

The second determination unit is configured to, upon detecting a target pixel having a detection distance less than the detection-distance threshold and the number of target pixels being greater than or equal to a target-pixel threshold, determine that the current-frame point cloud contains a region of interest.

In one implementation, the adaptive module 901 may comprise a first registration unit, a second registration unit, a motion-state determination unit, and a to-be-matched-frame determination unit.

The first registration unit is configured to perform point cloud registration between the current-frame point cloud and the adjacent next-frame point cloud to obtain a first transformation matrix.

The second registration unit is configured to perform point cloud registration between the current-frame point cloud and a spaced-apart frame to obtain a second transformation matrix.

The motion-state determination unit is configured to determine the motion state of the LiDAR based on the first transformation matrix and the second transformation matrix.

The to-be-matched-frame determination unit, upon determining that the LiDAR is in a non-motion state, designates the adjacent next-frame point cloud as the frame to be matched, until the LiDAR is detected to be in a motion state or the cumulative frame count exceeds a cumulative-frame-count threshold.

In one implementation, the matching module 902 is configured to compute, by template matching, a similarity between the region of interest of the frame to be matched and the region of interest of a template image; and to determine the template matching result based on the similarity.

In one implementation, the overlap identification module 904 is configured to, upon the number of occluded frames being greater than or equal to the occluded-frame threshold, identify an occlusion-overlap region based on the target positions corresponding to the plurality of occluded frames, comprising: matching the target-position coordinates of the multiple occluded frames; and if a region having identical position coordinates exists, determining that an occlusion-overlap region exists; otherwise, determining that no occlusion-overlap region exists.

In one implementation, the warning module 905 is configured to perform an occlusion warning operation if an occlusion-overlap region exists, comprising: determining the number of point cloud frames in which an occlusion-overlap region exists; and if the number of point cloud frames in which an occlusion-overlap region exists is greater than the occlusion-alarm cumulative-frame threshold, performing the occlusion warning operation.

In one implementation, the occlusion detection apparatus further comprises a display module configured to display the occlusion region in the point cloud.

It should be noted that the information exchange, execution processes, and other details among the various units above, being based on the same concept as the method embodiments of the present application, have specific functions and technical effects that may be referenced in the method embodiments section and will not be repeated here.

Therefore, the occlusion detection apparatus provided by the embodiments of the present application is likewise capable of, through adaptive static frame identification, accurately identifying the frame to be matched for occlusion detection, thereby effectively reducing the impact of erroneous motion-state identification on occlusion detection, accurately identifying occlusion conditions such as window cover contamination of a LiDAR, and providing early warnings, thus enhancing the safety performance of the LiDAR.

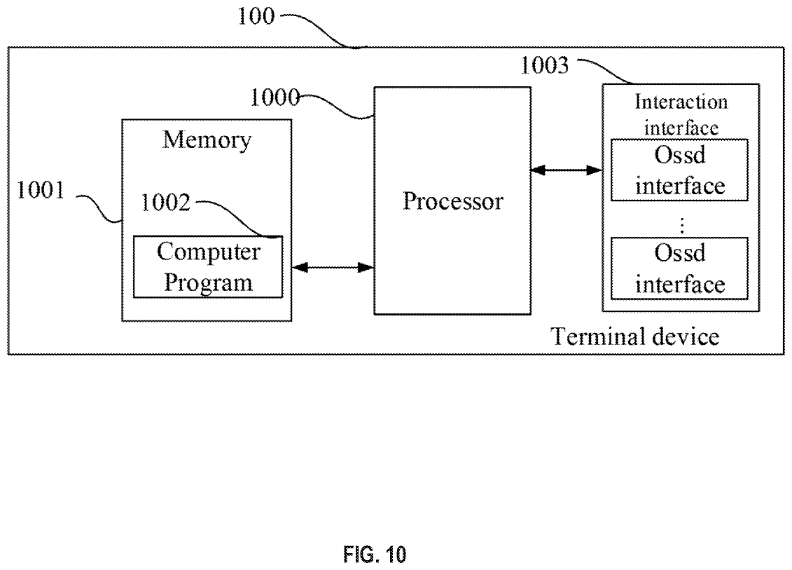

FIG. 10 is a structural schematic diagram of a terminal device provided by an embodiment of the present application. As shown in FIG. 10, the terminal device 100 comprises: a processor 1000, a memory 1001, and a computer program 1002 (e.g., an occlusion detection program) stored in the memory 1001 and executable on the processor 1000. As shown in FIG. 10, the terminal device may further comprise an interaction interface 1003, wherein the interaction interface 1003 may comprise at least two OSSD (Output Signal Switching Device) interfaces. When the processor executes the occlusion detection program and identifies that a safety monitoring space contains an intrusion object, at least one OSSD interface is designated as an external interface satisfying functional safety standard requirements to output a warning signal—for example, redundant OSSD interfaces may be designated as external interfaces to achieve functional safety. When the processor 1000 executes the computer program 1002, the steps in each of the foregoing occlusion detection method are implemented, for example steps S11 through S15 shown in FIG. 3. In some embodiments, when the processor 1000 executes the computer program 1002, the functions of each module/unit in the foregoing terminal device embodiments are implemented, for example the functions of units 901 through 905 shown in FIG. 9.

Exemplarily, the computer program 1002 may be partitioned into one or more modules/units, which are stored in the memory 1001 and executed by the processor 1000 to complete the present application. The one or more modules/units may be a series of computer program instruction segments capable of performing specific functions; the instruction segments are used to describe the execution process of the computer program 1002 in the terminal device 100. For example, the computer program 1002 may be partitioned into an acquisition unit, a determination unit, and a computation unit. For the specific functions of each unit, please refer to the relevant descriptions in the embodiment corresponding to FIG. 10; no further elaboration is provided here.

The terminal device may comprise, but is not limited to, a processor 1000 and a memory 1001. Those skilled in the art will appreciate that FIG. 10 is merely an example of the terminal device 100 and does not constitute a limitation on the terminal device 100. It may comprise more or fewer components than those shown, or certain components may be combined, or different components may be included. For example, the terminal device may also comprise input/output devices, network access devices, a bus, and so forth.

The processor 1000 may be a Central Processing Unit (CPU), or may be other general-purpose processors, a Digital Signal Processor (DSP), an Application Specific Integrated Circuit (ASIC), a Field-Programmable Gate Array (FPGA) or other programmable logic devices, discrete gates or transistor logic devices, discrete hardware components, or the like. A general-purpose processor may be a microprocessor or any conventional processor.

The memory 1001 may be an internal storage unit of the terminal device 100, such as a hard disk or internal memory of the terminal device 100. The memory 1001 may also be an external storage device of the terminal device 100, such as a plug-in hard disk, a Smart Media Card (SMC), a Secure Digital (SD) card, a Flash Card, and the like equipped on the terminal device 100. Further, the memory 1001 may comprise both an internal storage unit and an external storage device of the terminal device 100. The memory 1001 is used to store the computer program and other programs and data required by the terminal device. The memory 1001 may also be used to temporarily store data that has been or is to be output.

It is understood that the occlusion detection methods provided in each of the foregoing method embodiments may all be implemented based on the terminal device shown in FIG. 10.

The embodiments of the present application further provide a computer-readable storage medium. A computer program is stored in the computer-readable storage medium, and when the computer program is executed by a processor, the occlusion detection method described above is implemented.

The embodiments of the present application provide a computer program product, wherein when the computer program product runs on a terminal device, the terminal device implements the occlusion detection method described above.

Those skilled in the art can clearly understand that, for convenience and brevity of description, the division of each functional unit and module described above is given by way of example only. In actual applications, the foregoing functions may be distributed among different functional units and modules as needed, i.e., the internal structure of the terminal device may be divided into different functional units or modules to accomplish all or part of the functions described above. Each functional unit and module in the embodiments may be integrated into one processing unit, or each unit may exist physically as a separate unit, or two or more units may be integrated into one unit. The integrated unit may be implemented either in the form of hardware or in the form of a software functional unit. Furthermore, the specific names of each functional unit and module are only for the purpose of distinguishing them from each other and do not limit the scope of protection of the present application. For the specific working processes of the units and modules in the foregoing system, reference may be made to the corresponding processes in the foregoing method embodiments; no further elaboration is provided here.

In the foregoing embodiments, the descriptions of each embodiment each have their own emphasis. For parts not described or recorded in detail in a particular embodiment, reference may be made to the relevant descriptions in other embodiments.

Those of ordinary skill in the art can appreciate that the units and algorithm steps of each example described in connection with the embodiments disclosed herein can be implemented in electronic hardware, or in a combination of computer software and electronic hardware. Whether these functions are performed in hardware or software depends on the specific application and design constraints of the technical solution. Professionals may use different methods to implement the described functions for each specific application, but such implementations should not be considered beyond the scope of the present application.

What is claimed is:

1. An occlusion detection method, comprising:
performing region-of-interest detection based on point cloud data, and upon determining from the point cloud data that a current-frame point cloud is a first frame having a region of interest, initiating adaptive static frame identification to determine a frame to be matched;
performing template matching on the frame to be matched to obtain a template matching result;
upon the template matching result indicating successful template matching, recording a target position and recording the frame to be matched as an occluded frame;
upon a number of occluded frames being greater than or equal to an occluded-frame threshold, identifying an occlusion-overlap region based on target positions corresponding to a plurality of the occluded frames; and
if an occlusion-overlap region exists, performing an occlusion warning operation.

2. The occlusion detection method according to claim 1, wherein when the method is performed by an off-axis LiDAR, the region of interest comprises a void region, and the performing region-of-interest detection based on point cloud data comprises:
upon the current-frame point cloud comprising positions having a reflectivity of zero, extracting the positions having a reflectivity of zero from the current-frame point cloud to obtain an initial mask region;
performing a morphological opening operation on the initial mask region to obtain a post-opening mask region; and
if a target void region exists, determining that the current-frame point cloud contains a region of interest, wherein the target void region is the region obtained by removing a theoretical occlusion region and a sky region from the post-opening mask region.

3. The occlusion detection method according to claim 1, wherein the region of interest comprises a region corresponding to pixels having a detection distance less than a detection-distance threshold, and the performing region-of-interest detection based on point cloud data comprises:
determining the detection distance of pixels of the current-frame point cloud based on the current-frame point cloud data; and
upon detecting a target pixel having a detection distance less than the detection-distance threshold and a number of target pixels being greater than or equal to a target-pixel threshold, determining that the current-frame point cloud contains a region of interest.

4. The occlusion detection method according to claim 1, wherein the initiating adaptive static frame identification upon determining from the point cloud data that the current-frame point cloud is the first frame having a region of interest, and determining a frame to be matched, comprises:
performing point cloud registration between the current-frame point cloud and an adjacent next-frame point cloud to obtain a first transformation matrix;
performing point cloud registration between the current-frame point cloud and a spaced-apart frame to obtain a second transformation matrix;
determining the motion state of a LiDAR based on the first transformation matrix and the second transformation matrix; and
upon determining that the LiDAR is in a non-motion state, designating the adjacent next-frame point cloud as the frame to be matched, until the LiDAR is detected to be in a motion state or the cumulative frame count exceeds a cumulative-frame-count threshold.

5. The occlusion detection method according to claim 1, wherein the performing template matching on the frame to be matched to obtain a template matching result comprises:
computing, by template matching, a similarity between the region of interest of the frame to be matched and the region of interest of a template image; and
determining the template matching result based on the similarity.

6. The occlusion detection method according to claim 1, wherein the identifying an occlusion-overlap region based on target positions corresponding to the plurality of occluded frames, upon a number of occluded frames being greater than or equal to the occluded-frame threshold, comprises:
matching the target-position coordinates of the plurality of occluded frames; and
if a region having identical position coordinates exists, determining that an occlusion-overlap region exists; otherwise, determining that no occlusion-overlap region exists.

7. The occlusion detection method according to claim 1, wherein the performing an occlusion warning operation if an occlusion-overlap region exists comprises:
determining the number of point cloud frames in which an occlusion-overlap region exists; and
if the number of point cloud frames in which an occlusion-overlap region exists is greater than an occlusion-alarm cumulative-frame threshold, performing the occlusion warning operation.

8. An occlusion detection apparatus, comprising:
an adaptive module configured to perform region-of-interest detection based on point cloud data, and upon determining from the point cloud data that a current-frame point cloud is a first frame having a region of interest, to initiate adaptive static frame identification to determine a frame to be matched;
a matching module configured to perform template matching on the frame to be matched to obtain a template matching result;
a recording module configured to, upon the template matching result indicating successful template matching, record a target position and record the frame to be matched as an occluded frame;
an overlap identification module configured to, upon a number of occluded frames being greater than or equal to an occluded-frame threshold, identify an occlusion-overlap region based on target positions corresponding to a plurality of the occluded frames; and
a warning module configured to perform an occlusion warning operation if an occlusion-overlap region exists.

9. A terminal device comprising a memory, a processor, and a computer program stored in the memory and executable on the processor, wherein when the processor executes the computer program, the following operations are implemented:
performing region-of-interest detection based on point cloud data, and upon determining from the point cloud data that a current-frame point cloud is a first frame having a region of interest, initiating adaptive static frame identification to determine a frame to be matched;
performing template matching on the frame to be matched to obtain a template matching result;
upon the template matching result indicating successful template matching, recording a target position and recording the frame to be matched as an occluded frame;
upon a number of occluded frames being greater than or equal to an occluded-frame threshold, identifying an occlusion-overlap region based on target positions corresponding to a plurality of the occluded frames; and
if an occlusion-overlap region exists, performing an occlusion warning operation.
